(19) United States
(12) Patent Application Publication
(10) Pub. No.: US 2004/0139044 A1
(43) Pub. Date: Jul. 15, 2004

(54) System for detecting and storing individual-specific data, a corresponding storage element, and a method for rescuing and/or medically caring for living beings in an emergency

(76) Inventor: Jorg Rehwald, Hamburg (DE)

Correspondence Address: VENABLE, BAETJER, HOWARD AND CIVILETTI, LLP, P.O. BOX 34385, WASHINGTON, DC, 20043-9998, US

(21) Appl. No.: 10/466,071

(22) PCT Filed: Jan. 9, 2002
(86) PCT No.: PCT/EP02/00140

(30) Foreign Application Priority Data
Jan. 10, 2001 (DE) 101 00 722.1
Oct. 16, 2001 (EP) 01 124 641.0

(51) Int. Cl. G06F 7/00

(52) U.S. Cl. 707/1

(57) ABSTRACT

A storage element for storing individual-specific data comprises at least two storage areas. Each storage area of the storage element is provided with an assigned logon authorization. Methods of detecting and storing individual-specific data and of providing emergency services utilize the storage element. A system for storing and detecting individual-specific data includes a computer, the storage element, and a connection device that allows coupling of the storage element with the computer.

The invention relates to a storage element with at least two storage areas for storing individual-specific data, as well as a system for recording and storing individual-specific data, comprising a computer, a corresponding storage element and a connection device. The invention also relates to a system for recording and storing individual-specific data, comprising a first computer which contains different storage areas on a computer storage element. The invention furthermore relates to a method for rescuing and/or providing medical care to living beings in emergency situations, in particular individuals involved in accidents, as well as to a computer program product for realizing this method.

Individual-specific data in particular refers to data that relates to individuals, but can also relate to animals.

Storage elements and systems for storing individual-specific data are known, for example, from the health services. It is standard procedure nowadays to store a patient's master data on an insurance card. The patient carries along this insurance card and hands it over, for example during a visit to the physician, so that the data stored on the storage element can be input into a computer system at the physician's office. The master data in this case comprise in particular the name, the name, the health insurance information and the age of the patient.

Systems already exist at the physician's office, which store additional patient data on a computer, for example previous diagnoses, laboratory tests and previously issued prescriptions. In particular the anamnesis or case history of a patient is extremely important to the treating physician. The physician normally issues a prescription based on the latest diagnosis, which the patient then takes to the pharmacy to be filled.

This method and/or this system is relatively involved. The pharmacist must input the prescription data into his/her computer system for the corresponding accounting. Thus, the traditional action of filling out paper prescriptions is time consuming.

In an emergency situation, for example involving an accident, it is very difficult for the treating physician to obtain a case history of the emergency patient. Only a few emergency patients carry along an emergency information card. In most cases, the information stored on this card is furthermore very incomplete.

Problems additionally come up during the rescue of accident victims or persons who have fainted because much time passes during the rescue of these individuals before they are provided with the proper initial medial care. As a rule, the individuals involved in the emergency situation are not admitted to an appropriate special clinic, but are instead admitted to a general clinic for the initial treatment. A decision concerning a specialized treatment is made only afterwards. In emergency situations of this type, much time furthermore passes until data relating to patient is available. This is particularly true if the accident victim has fainted and/or does not respond.

Accordingly, it is the object of the present invention to improve the medical care in general and in particular to improve the rescue of individuals involved in accidents or emergency situations, wherein data protection rights of individuals must be taken into consideration.

This object is solved with a storage element having at least two storage areas for storing individual-specific data, wherein different logon authorizations are assigned to the different storage areas.

With the storage element according to the invention, for example, auxiliary personnel at the physician's office can read the data in one storage area only while the physician provided with a special logon authorization can read and write data on additional storage areas. A storage element of this type can protect access to important diagnostic data such as blood type and allergies, so that it can be accessed only by the physician with logon authorization. If the storage element also comprises a storage area for prescriptions, the prescription data can be read easily and without problems by a pharmacist, which saves time and cost.

It is furthermore possible to store additional data in the memory, which can be authorized by the patient itself and can be read, for example, together with the physician.

The storage element preferably comprises at least one storage area configured as ROM, meaning an area that can be read only, as well as at least one additional storage area configured as RAM, meaning an area for reading and writing. The ROM, for example, is used to store master data such as the name and address, as well as information on the health insurance, the nearest relatives or a personal physician and, if possible, a passport photo. Other individual-specific data can also be stored, in particular biometric data such as an image of the iris or a finger print. The addresses and/or telephone numbers of individuals who should be notified in case of an emergency can also be stored. The RAM, which can be divided into several regions or fields, can be used to store diagnostic data such as heart diseases, metabolic diseases, circulatory diseases, lung diseases, infectious diseases such as hepatitis or HIV, allergies, neurological problems such as epilepsy and the blood type. Variables can be stored in another field, i.e. the results of laboratory tests, data from the most recent checkups, neoplasias, the results of X-rays of, for example, the thorax, medications and the most recent prescription, operations, pregnancies, implants such as silicon and, for example, also the status of teeth, meaning whether the patient wears a prosthesis. A prescription written by a physician could be entered into a different RAM field. The patient can then take the storage element to a pharmacy where the pharmacist can view the master data of the patient and the prescription field.

It is preferable if the second storage area that is assigned to second logon authorization can be written on with a first logon authorization for the associated first storage area and can be read and deleted with the second logon authorization. An additional storage area, i.e. the prescription field, is furthermore provided and can be read without logon authorization. Without logon authorization in this case is understood to mean in particular the normal and standard use of a card reader by the auxiliary personnel in a physician's office, wherein access is obtained, for example, to a ROM in which the patient's master data are stored.

The two storage areas that require logon authorization are preferably located in at least one RAM and/or the storage area that can be read without logon authorization is located in a ROM.

The storage element preferably is a one-piece element. If this storage element is advantageously located on a flat configuration, in particular is disposed on a card, then a standard health insurance card can be used. In that case, the card is preferably a so-called chip card in the form of a credit card or a “smart card.”

Different individuals can be provided with different codes if the storage content of the at least two storage areas is advantageously provided with a different coding, so that the respective individuals have access only to very specific areas on the storage element.

The object is furthermore solved with a system for recording and storing individual-specific data, comprising a computer, a storage element as described in the above, and a connection device. The storage element can engage in the connection device in such a way that data can be read from the storage element into the computer and/or can be written from the computer to the storage element.

A system of this type is advantageous for emergency events, for example, if a person has become an accident victim. Once the physician arrives at the accident scene, he/she must only retrieve the health insurance card of the accident victim and engage this card in the connection device to obtain access to the corresponding relevant data.

It is preferable if a logon element is provided for transmitting data to the computer and/or via the computer to the connection device, wherein the data contain at least a portion of the logon authorization. As a result, not every individual can read all the data on the storage element, but only those individuals having the respective logon authorization and/or the corresponding logon element. The logon element in this case can be a storage element on a card, for example, which the physician always carries. A portion of the logon authorization can be stored on this card. The card is preferably also secured with a PIN code, so that it cannot be used by other unauthorized individuals if the respective access card of a physician is lost. The PIN code is an example of a preferably additional section of the logon authorization that can be transmitted via a communication means in the form of data to a computer and/or via the computer to the connection device.

The office help at the physician's office, for example, can read only the ROM area of the storage element. The logon element can for this can be a code that is stored on a computer and is supplied to the card during the reading in order to open up an area that is assigned to the logon code of the logon element. Within the framework of this invention, a computer of this type can also be a card reader. Another area, for example a RAM area, is intended for viewing by the physician only. The physician can read and/or write in this area with the aid of a corresponding logon element, for example a code stored in the computer and a personal code which must be input by the physician into his/her computer, in particular a barcode or a biometric code. However, a logon element can also be a storage element installed on a portable card. Of course, the physician preferably should also be able to read the ROM area. A pharmacist can read and correspondingly delete only a portion of the RAM, namely the portion set aside for the prescription. For this, a logon element is provided, which can be a code existing in the card reader or computer at the pharmacy and can be transmitted via an interface to the storage element on the insurance card to provide the pharmacist with access to this area.

Remote data transmission means are preferably provided, in particular comprising a mobile telephone. These remote data transmission means makes it possible, for example, to transmit individual-relevant data to a hospital, so that the hospital staff can take all necessary steps to prepare for the arrival of an accident victim.

The object of the invention is furthermore solved with a system for recording and storing individual-specific data, comprising a first computer that contains different storage areas on a computer storage element, wherein at least in part different storage areas are assigned to different logon authorizations, further comprising a portable storage element on which data can be stored and a connection device. The portable storage element can be made to engage in the connection device in such a way that data from the portable storage element can be transferred to the first computer, wherein the individual-specific data from one of the areas with logon authorization on the computer storage element can be read and/or changed through entering a corresponding logon authorization or using an existing logon authorization.

This solution according to the invention, for which the first computer is provided with different storage areas on a computer storage element and the storage areas at least in part comprise different logon authorizations, permits the intermediate storage of individual-specific data on a fast computer system and, with the aid of this computer system, allows different individuals with different logon authorizations access only to the respective areas of the data.

It is preferable if remote data transfer means are provided, wherein the data can be transmitted from a first computer to a second computer that is assigned to the connection device. In that case, it is not necessary to store all data on the portable storage element. Additional data can be stored on a central computer, in particular the first computer as a server, which is a particular advantage for high amounts of data. In that case, access can be obtained to corresponding storage areas of the computer storage element on the first computer with the aid of the portable storage element and the logon authorizations and/or the logon authorization elements or the codes. For example, if the data on the patient's insurance card is input following an accident, the data are transmitted together with a physician code to the first computer at the hospital, so that the data accessible with this logon authorization can be transmitted back to the physician at the scene of the accident and can be read and, if necessary, can be changed by the physician on his/her portable, second computer and/or a mobile telephone, which in particular functions as a computer.

If an electromagnetic signal can be transmitted and received, preferably with the connection device for recognizing the data on the portable storage element, wherein the portable storage element comprises a transponder, it is not even necessary to find the insurance cards, for example at the scene of an accident. It is sufficient to come close to the respective insurance card to transmit the respective data, for example from the insurance card to a computer of the treating physician. A scanner using electromagnetic rays is used, for example, for reading the data on the chip, which saves a great deal of time during an accident. A card of this type, carried along by the patient, preferably comprises a so-called active and/or passive controller. This technique permits a non-problematic determination of whether or not a patient carries precisely this patient card. The controller in particular consists of a small program that is initialized with the aid of a coil, with electromagnetic energy provided by a carrier. The initializing carrier can be a hand-held computer or a notebook computer with small accessory device. The carrier initializes the coil whereupon the chip set anchored on the card is supplied with energy. Controlled by its program, this chip set in turn reads specific data on the memory and makes these data available to the network for transmittal. Slow networks such as the Ethernet can be used, corresponding to the IEE802.X Standard. The hand-held computer can be linked via a standard serial interface to the computer processing the data for the purpose of further transmitting the data or, in the case of emergency measures at the accident location, to the notebook with remote data transmission (DFU) link and corresponding protocols. This technique can also be used in the field of veterinary medicine.

The advantage of this technique is that especially in cases involving a large number of accident victims, ranging from interstate accidents to fires in a tunnel, the time for questioning and maybe searching for data to help with the rescue and save lives is extremely reduced and the rescue personnel can operate with a much higher effectiveness, which leads to considerable cost savings. Not to be neglected in this case is the considerable reduction in secondary health problems that may result from unknown and undetected injuries, which is not possible without the transfer of data from the storage element with the aid of a passive and/or active controller.

The object is furthermore solved according to the invention with a computer program product and/or a technique for writing and/or reading data on a first storage element, as described in the above. In order to read data in and/or write data on at least one storage area of the first storage element that is at least partially secured by at least one logon authorization, a logon authorization is transmitted to a storage area on a second storage element and is compared to at least one logon authorization that can be specified on the first storage element. If the logon authorization matches at least one of the specified logon authorizations, the storage areas of the first storage element, assigned to this logon authorization, are released or unblocked.

As a result of the inventive computer program product and the inventive method, it is possible to release corresponding storage areas on the first storage element, depending on the logon authorization. Different logon authorizations can be considered, for example, for a physician, for a physician's aide and for the pharmacy. For example, the physician is provided with an additional card containing at least a portion of the logon authorization. This additional card must be inserted, for example, into a card reader or a computer to input the logon authorization and/or the corresponding code thereon. The physician then enters another code, i.e. a PIN code, to obtain logon authorization to respective areas of the first storage element. Alternatively, the physician can also record and input biometric data to obtain a logon authorization.

To display the released data, the data from the first storage element are preferably input into an additional storage area on the second storage element and are then sent to a display unit. For writing in the released storage areas of the first storage element, data are advantageously input into the second storage element and are transmitted from there to the released storage area on the first storage element where they are stored. If, as is advantageous, a remote data transmission is planned, the first storage element can be at a different location from the second storage element.

According to the invention, a storage element arranged on a card is used for storing and/or changing individual-specific data relating to the area of health services, in particular the area of emergency medicine, so as to quickly detect the case histories of accident patients.

This object is furthermore solved with a method for rescuing and/or medically caring for living beings in emergency situations, in particular people involved in accidents. With this method, a central unit contains in particular current data relating to available mobile rescue objects, in particular emergency physicians, emergency medical technicians, emergency-room physicians, ambulances and/or emergency vehicles. Following a report of an emergency situation involving living beings to the central unit, a suitable mobile rescue object is assigned by the central unit to the emergency situation based on the available emergency situation information and/or the data available on mobile rescue objects. The central unit then transmits a message relating the emergency situation to the at least one assigned mobile rescue object. Corresponding to the accident location and/or the type of accident that occurred, the most suitable rescue vehicle available at the moment and/or the most qualified rescue personnel are automatically determined.

To ensure optimum care for accident victims or people in emergency situations, the central unit must have the requisite data on the rescue vehicles and/or the rescue personnel. Already existing data relating to the accident or emergency situations can additionally be considered when determining the rescue objects. A report of the event can be sent, for example via telephone, to a main command post for rescue operations, i.e. reached via the known emergency telephone numbers, wherein the main command post for the rescue is either connected permanently to the central unit or is connected once the accident report is received. Data on accidents and emergency situations can be collected and administered or monitored and controlled in the central unit, either for the region and/or beyond the region as well as nationally and globally. A central computer and/or a network of computers are primarily used for this, which can optimally assign rescue objects to the respective event either locally and/or regionally as well as (inter)nationally following a report of an accident.

Within the framework of this invention, reporting an emergency event in particular refers to the transfer of data that is specific to this emergency event. These data can be input in schematic form into a computer system by a person taking the telephone call and can be transmitted to the central unit. The data can also be transmitted automatically, for example with the aid of a voice-controlled user guidance by the caller. The accident and/or emergency event alternatively can also be reported automatically. For example, a vehicle carrying endangered cargo can be equipped with an accident-signaling device which, in the event that the vehicle should be involved in an accident, automatically reports this accident to a central unit via remote data transmission, i.e. mobile radio transmission. The accident location can be detected, for example, with mobile radio technology. Data relating to the endangered cargo can also be transmitted along with the accident report. Yet another modification calls for vehicles, airplanes, ships and trains to be provided with a (semi-) automatic reporting system and/or a device of this type. When transporting people, the number of transported individuals can also be reported.

To ensure optimum care for individuals involved in an accident, for example, it is advantageous if the data on the mobile rescue objects contain data relating to the availability and/or the location and/or the qualification and are transmitted to the central unit.

Any change in the data relating to mobile rescue objects should preferably be transmitted. As a safety measure, the data on the mobile rescue objects should be updated at least in part and sent to the central unit at predetermined time intervals.

According to a further modification of the method, the data and/or the location of a mobile rescue object are transmitted with the aid of a GPS device to the central unit. By making use of the global positioning system (GPS), the central unit consequently has information on where the available rescue object is located at the moment. Thus, it is always possible to find out which rescue object, i.e. an emergency physician, is located near the emergency event. The term “qualification of a rescue object,” for example, is understood to mean the training and professional qualifications of the available rescue personnel. In the case of vehicles, for example, the qualification refers to the capacity and equipment and/or outfitting of the vehicle. Alternatively, the locations of vehicles can also be determined via mobile radio technology.

The rescue of accident victims can be improved further if the data on mobile rescue objects are updated, preferably at predetermined time intervals.

If a respective mobile rescue object, for example a physician who is less qualified than an emergency physician, is already present at the location for the emergency or accident, a request for an additional mobile rescue object can preferably be transmitted to the central unit to reinforce and aid the rescue personnel on location. Based on the request and/or the data relating to available mobile rescue objects, the central unit can assign at least one additional mobile rescue object to the event and can transmit a message to the additional mobile rescue object.

It is furthermore advantageous if, following the emergency event report to the mobile rescue object, the mobile rescue object sends a cancellation message to the central unit. The central unit thus has knowledge of available and not available rescue objects, meaning objects that are either deployed or which are available for deployment.

One advantageous modification of the solution according to the invention provides that the central unit is connected to stationary rescue installations and contains data, in particular updated data, on the stationary rescue installations. As a result, the central unit stores information on available resources, for example hospitals and specialized clinics, so that the central unit generally is always informed of which medical measures and installations (i.e. in a special clinic for an acute emergency) are available and whether a bed, for example, is empty. Within the framework of this invention, a connection to stationary rescue installations in particular means a connection to respectively one data processing system, i.e. a computer in the rescue installations, on which relevant data relating to the rescue installations are stored and updated.

The quality of care during a rescue operation can be improved further if, following a message indicating the need for further treatment of the living being, if necessary by the mobile rescue object to the central unit, a suitable rescue installation is determined based on the need for further treatment and/or based on the data relating to stationary rescue installations and if information on the located rescue installation is transmitted to the mobile rescue object. The need for further treatment is determined, for example, if an emergency physician transmits data relating to the accident victims to the central unit via a data line, i.e. via mobile radio transmission. A standardized protocol can be used by the emergency physician to report the diagnosis.

The data relating to the determined rescue installation can comprise the location of the rescue installation, for example, wherein the coordinates and the address can be transmitted. The coordinates can then be entered into the navigational system of a mobile rescue object, such as an ambulance, so that the navigation can start immediately and automatically.

It is furthermore advantageous if during and/or after the living being involved in an accident is cared for, data are exchanged between the mobile rescue object and/or the central unit, in particular patient data and/or data relating to further treatment. As a result of this data transfer, information relating to an accident victim can be obtained quickly and immediately from other medical computer networks and can be made available to a specialist in a selected emergency clinic while the patient is still en route to the emergency clinic. Valuable time can thus be saved when rescuing people since the specialist can make preparations and gather information while the individual to be rescued is transported to the location.

Within the framework of this invention, a mobile rescue object comprises a computer, on which the actual data for the emergency event can be stored and by means of which these data are supplied to a remote data transfer device in order to communicate with the central unit.

To select a suitable stationary rescue installation that meets the further treatment requirements of the person to be rescued, it is advantageous if the data on the stationary rescue installations contain data on whether the installation is available and/or meets the qualifications and/or is within reaching distance and if the information is then transmitted to the central unit.

The medical care is further improved if the data on stationary rescue installations is updated, preferably at predetermined time intervals and/or following a change in the data and/or the status. Thus, it is possible to react quickly and spontaneously to the momentary requirements of an accident event, shortly after the accident occurs. For example, if a bed becomes available in a hospital, this information is immediately transmitted to the central computer and/or the central unit, so that the empty bed is available.

A physician thus can also obtain information on the patient to be treated before the patient is admitted if data relating to the accident event and/or the living being that is hurt in an accident (human or animal) are transmitted to the stationary rescue installation.

So that clinics and emergency clinics can react within a short time to the accident event and can take measures, it is advantageous according to one modification of the invention if the data collected while caring for the living being and/or during the transport are transmitted to the associated stationary rescue installation.

The object is further solved with a computer program with program code for realizing the above-described method for rescuing and/or medically caring for living beings involved in an accident, in particular people or animals, so that the above-described method steps can be carried out if the program runs on at least one computer.

The computer program can be realized with a system for rescuing living beings, wherein the system comprises at least one central unit, a mobile rescue object and a stationary rescue installation. The central unit and the rescue objects are preferably linked via a radio data transmission line. The link between central unit and rescue installation can be realized via a remote data transmission line.

A computer program is furthermore provided with a program code that is stored on a machine-readable carrier for realizing the above-described method for rescuing and/or medically caring for living beings, so that the above-described method steps can be realized if the program is running on a computer.

Within the framework of this invention, practicing physicians can also use the method according to the invention to provide suitable medical care to a patient in a correspondingly suitable hospital. The physician is provided with timely information on the occupancy of beds and operating rooms and thus can admit his/her patient to a hospital.

The invention is described in the following without limiting the general inventive idea, with the aid of exemplary embodiments and reference to the drawings, to which we expressly refer with respect to all details of the invention not explained further in the text.

Shown are in:

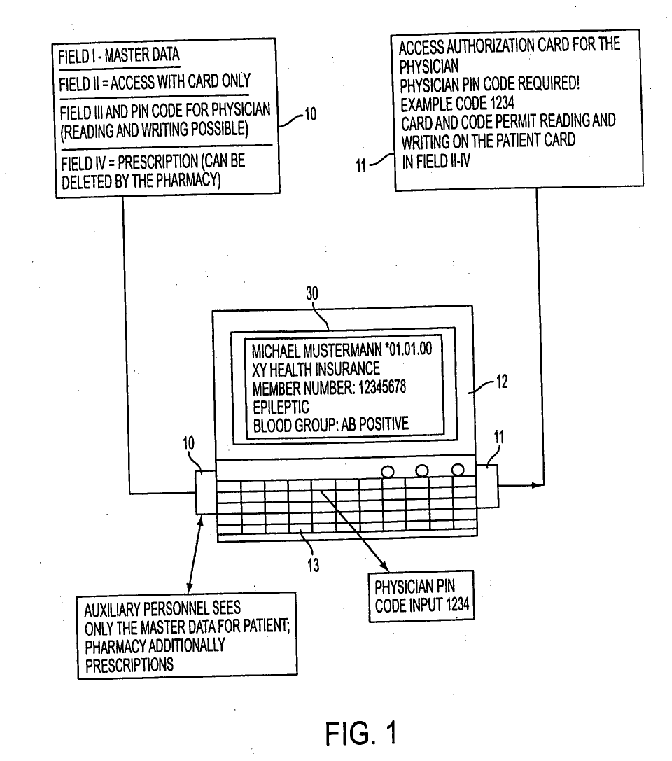

FIG. 1 a schematic representation of a system according to the invention for detecting and storing individual-specific data;

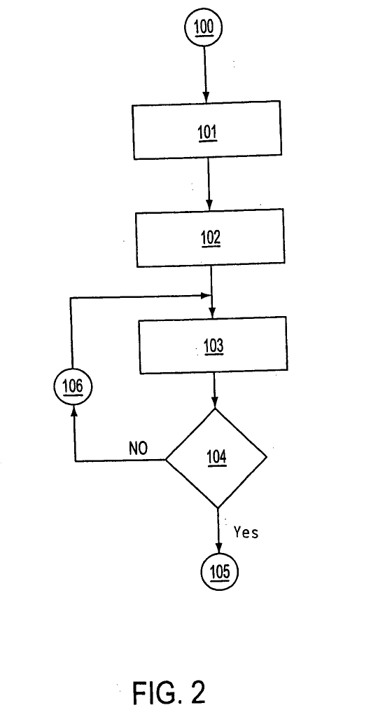

FIG. 2 a simplified flow chart of a process sequence in a physician's office;

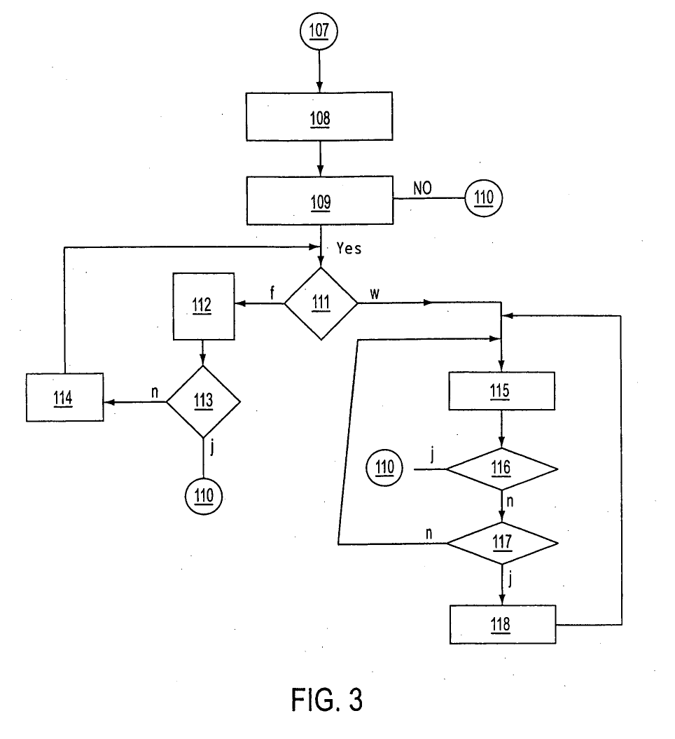

FIG. 3 a simplified flow chart for a specific section of the process sequence in a physician's office;

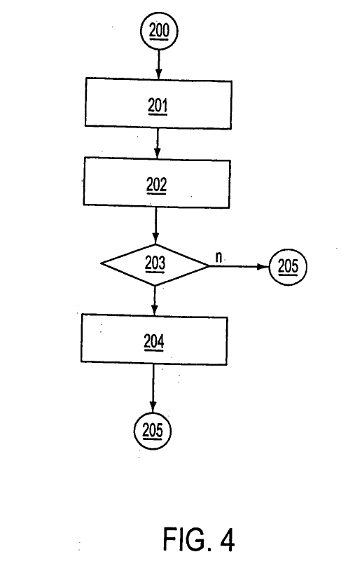

FIG. 4 a simplified flow chart for a process sequence in a pharmacy;

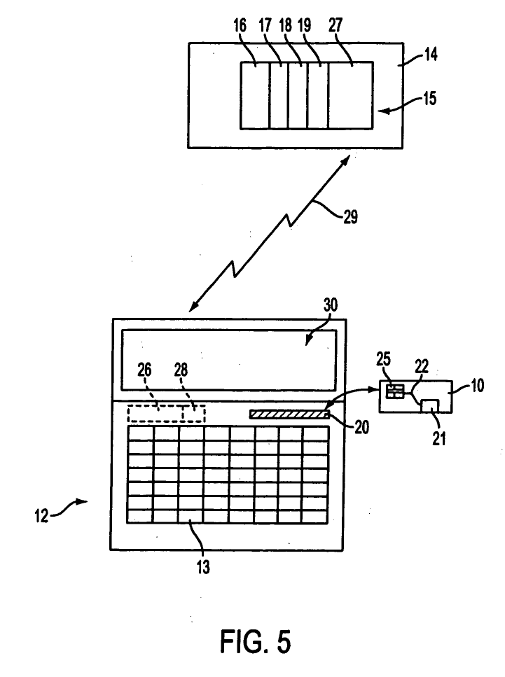

FIG. 5A schematic representation of another exemplary embodiment of a system for detecting and storing individual-specific data and/or data on animals and

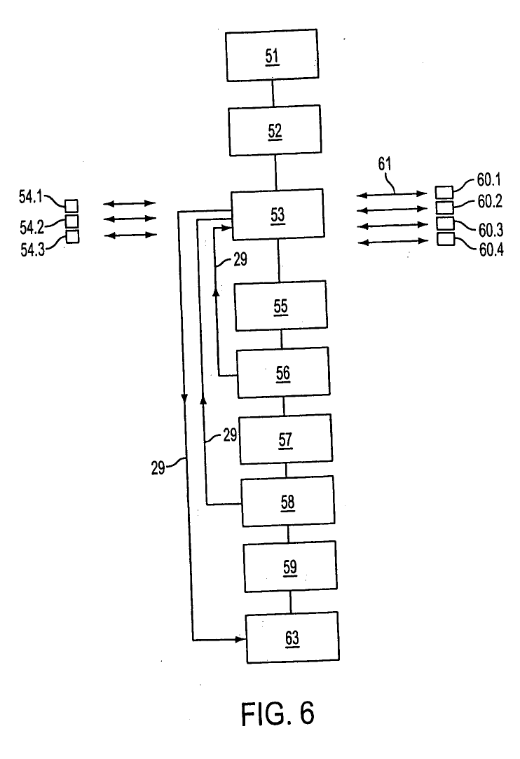

FIG. 6 a simplified diagram showing the sequence of method steps for rescuing people or animals involved in an accident.

The same elements are provided with the same reference numbers in the following Figures. The respective elements will not be introduced again.

FIG. 1 shows a schematic representation of an exemplary embodiment of a system for detecting and storing individual-specific data. An insurance card 10 is divided into 4 fields, namely the field 1 for storing the master data and the fields II, III and IV where additional data can be stored. In field I, data can be input without further logon authorization and it contains master data as described in the above. The fields II and III can be accessed only with a logon authorization card 11 and a physician PIN code, wherein the stored contents can be read and data can be written in. Field II, for example, contains data relating to diagnoses while field III contains additional data, as previously described in the above. Field IV may contain the contents of a prescription, wherein the physician can write and delete data in this field, while the pharmacist can only read and delete data.

A patient arrives at the physician's office and hands his insurance card to the office personnel for insertion into a computer 12. The personnel at the physician's office can then load in the master data and can view it on the monitor. The physician, who also has a computer 12 in his/her office, inserts the respective logon authorization card into a corresponding interface and also enters a PIN code. Together with the PIN code, the logon authorization card enables the physician to read and write on the insurance card in fields II, III and IV. The code is input via the keyboard 13. The data can then be viewed on the monitor 30.

Of course, it is possible to transfer the data on the insurance card via a data line from the computer in the reception area to the computer in the physician's office. It is therefore not necessary to insert the insurance card into another card reader and/or storage device in the physician's computer. However, the variant shown in FIG. 1 where the insurance card as well as the logon authorization card of the physician are inserted into respectively different interfaces is preferred.

The flow chart in FIG. 2 shows a preferred sequence of steps in a physician's office. The sequence starts with step 100. Initially, the insurance card is inserted into a computer 12 (step 101) and the master data is loaded in (step 102). Next, the master data is displayed on the monitor (step 103), wherein standard computer programs are used to realize these steps. For this, data are loaded in the standard way onto a processor and are stored on corresponding storage areas of the computer and processed for display on the monitor.

An inquiry is made (step 104) to determine whether the insurance card was removed. If that is the case, the process sequence ends according to FIG. 2. If that is not the case, another inquiry is made at step 104. In field 106 it is possible to introduce an insertion. This insertion is described in further detail in a simplified sequence shown in FIG. 3.

Step 107 represents the start of the insertion at the physician's office. At step 108, the logon authorization card is inserted into the physician's computer and at step 109 the logon authorization is checked. If the logon authorization card does not contain a logon authorization that matches a corresponding logon authorization stored on the insurance card 10 or the computers, the end of the insertion by the “physician” occurs at step 110 in case of a “no.” If the logon authorization matches one of the stored logon authorizations (“yes”), then the field 111 awaits the input of a PIN code via a keyboard and the entered PIN code is checked. If the entered PIN code is incorrect (f), a counter previously set to zero is incremented upward by one (step 112). An inquiry is made at step 113 to see if the counter is higher than 3. If this inquiry is answered positively, the insertion by the physician ends with 110. If this inquiry is answered negatively (n), a warning appears at 114 on the monitor, and the system returns back to field 111. If the entered PIN code (w) is correct, the process continues on to field 115 where the additional fields of the insurance card are shown according to the input logon authorization. In field 116, an inquiry is made whether the access card has been removed. If that is the case (yes) the insertion ends at 110. If that is not the case (n), the system waits to see whether data are input (field 117). If no data is input, the process sequence reverts to field 115. If data are input, then the data on the insurance card are altered in field 118 and the system returns once more to field 115.

FIG. 4 shows a simplified process sequence, i.e. at a pharmacy, where the process sequence starts at 200. The insurance card is initially inserted into a card reader (field 201). In field 202, the logon authorization for the prescription area on the insurance card is transferred to the insurance card (field 202). In field 203, an inquiry is made as to whether the logon authorization is correct. If this is not correct (n), the process is stopped at the pharmacy. If the logon authorization is correct (y), the prescription data is indicated in field 204, if necessary the data from the computer system for billing the insurances is supplied to the pharmacist and is subsequently deleted in the prescription area and/or the field IV of the insurance card. Following this, the process ends at the pharmacy.

The above-described process sequences according to the preferred exemplary embodiments and also the additional embodiments are for the most part realized with computer program steps, known per se to the person skilled in the art, which can be realized without problems and do not require further explanations herein.

FIG. 5 shows another schematic representation of an exemplary embodiment, for which an external computer (14) that may be located at a clinic contains storage areas 16, 17, 18 and 19 for patient-relevant data. The storage area 27, shown only schematically herein, is designed to represent a storage area that may be located on the processor or hard drive. The different storage areas 16 to 19 are provided for the different fields containing patient data.

For example, an emergency physician at the accident location has a laptop or palm-size computer, meaning a computer (12). An insurance card 10, for example, is inserted into a connection device 20 that may be integrated into this computer (12). The data stored in the memory 25 of the insurance card 10 thus can be transferred to the physician if necessary, wherein the memory 25 in this case contains only master data. A schematically shown memory 26, installed on the computer 12, in particular comprises a storage area 28. The master data are subsequently displayed, for example on the monitor 30. Corresponding data are then transmitted, for example via a radio data transfer 29, to the computer 14. In addition, a logon authorization for the physician is stored in the storage area 28 of the memory 26. The logon authorization data and/or the logon authorization code are supplied via the data transfer 29 to the computer 14. The emergency physician furthermore enters a PIN code via the keyboard 13 into the computer 12. This PIN code is also transmitted to the computer 14. If the complete logon authorization, consisting of the logon authorization stored on the storage area 28 and the PIN code, is correct, then the physician can read the areas 16 to 19 of memory 15 and, if necessary, can also change these areas.

With this embodiment, the essential and individual-relevant data are thus stored in a computer, i.e. a computer at a clinic. However, the data can also be stored in a central computer that may store data for the whole country.

According to another exemplary embodiment that is also described with the aid of FIG. 5, all data on the insurance card 10 can alternatively be stored in the memory 25. That is to say, the data can be stored in the above-described, different areas that can be accessed with different logon authorizations. These data can be read with the aid of the logon authorization data in the storage area 28 of memory 26 and the PIN code, which is input by the physician.

It is advantageous if the insurance card is provided with a transponder 21 that is linked via a connecting line 22 to the memory 25 in case the insurance card is not found at the scene of the accident. In that case, the physician's laptop computer may comprises a type of radio transmitter that emits electromagnetic rays, which make it possible to read the data stored in the memory 25. The range for this can be correspondingly limited, so that data from different insurance cards disposed at distances of only a few meters from each other are not scrambled. The radio transmitter and/or the transmitter/receiver can also be provided in an accessory device for the computer 12 and can be linked to the computer with a data link. In that case, the insurance card functions as a type of ID (identification) tracker. Gigahertz waves are preferably coupled via a small antenna into a surface wave component in that case, wherein the surface waves are provided with a respective coding by the waveguide. The reflected wave is then once more limited and/or uncoupled and is received by a receiving device and further processed.

In particular, provisions must be made for a physician to access the data without the input of a special PIN code stored on the insurance card, which is valid only for the insurance card, because the insurance card and/or the patient may not respond at specific moments. The PIN code and the additional logon authorization data should therefore function independent of the respective individual insurance card. It also makes sense to provide the insurance card with a photograph of the patient to make possible a quick identification.

The access card and/or the logon authorization that is stored in a computer memory should be protected with a PIN code for the person with read/write authorization to avoid any misuse.

To embed a passport photo in the form of data and/or optically on the insurance card prevents the misuse of the card in case it is lost or stolen. The writing ability offers the advantage that a double diagnosis can be avoided, thus avoiding the costs tied thereto and the corresponding medical risks. In addition, the last-prescribed medication is preferably documented on the card, thus limiting the “hopping” between physicians as well as any double treatment due to a lack of knowledge of the previous treatment.

One preferred embodiment of the invention is the data transfer via the Intranet or the Internet or via radio or telephone

For the German territory, an interface protocol such as a Capi-link, for example, is preferably used for utilizing a pear-to-pear protocol via ISDN by making use of the batch transfer protocol TCP/IP batch for rapid data transport. A corresponding ISDN controller should support B-channel protocols in ISDN with the respective controller software.

These are, for example, X.75, HDLC transparent, transparent, X.25, ISO 8208 (X.25 DTE-DTE), X.31 case a/b, T.90, Fax G3, V.110 and V.120. This results in compatibility with generally used standards and equipment and thus a corresponding cost reduction. By including a Capi port, which makes available virtual modems for data links with X.32-X.75 data compression during the transfer, as well as with a compression method that conforms to Capi 2.0 specifications and/or V.42bis (Capi soft compression X.75/V.42bis), an uncomplicated connection can be established, even to analog networks.

It appears useful to provide direct access to medically relevant data between different clinics, from the ambulance to the clinic, from the physician to the clinic, from the clinic to the physician etc. This is useful particularly for acute deployments, e.g. mass accidents and for the disaster protection, where the implementation of a NDIS-WAN port can be advantageous. Accordingly, it is also possible to create UMTS and/or GSM connections. The remote data transfer between the physician's computers and/or the card reader for the physician and an emergency clinic and/or a hospital can be via a mobile radiotelephone service.

It is furthermore possible to fill out a medical protocol automatically, which can then be transmitted to the health insurances and/or the hospitals, preferably via remote data transmission. For the transfer, the data in particular can be encoded, so as to safeguard the data.

It is furthermore conceivable that other groups or individuals can obtain gain access to specific data. The police, for example, should be able to access data of individuals in order to be able to identify them. In addition, persons to be contacted immediately in case of an accident can be noted on the chip card.

FIG. 6 shows a simplified, schematic embodiment of a method for rescuing and/or medically caring for living beings (involved in an accident). The method can be used not only for rescuing people in an emergency, but also for rescuing animals, particularly dogs and horses.

Following an accident or emergency event 51 that results in injuries or causes other problems for people and/or an animals, a report 52 of the accident event 51 is transmitted to a central computer 53. The accident event 51 is reported, for example, via telephone to the main office for rescue services and can include information on the location of the accident and/or the type of accident, so that a respective report 52 is then transmitted from the rescue services main office to the central computer 53. The main office can be connected permanently to the central computer 53 via a corresponding remote data link or can be connected only if an accident 51 occurs.

The central computer 53 is additionally linked to mobile rescue objects 54.1, 54.2, 54.3 via a radio link or via mobile data lines. The mobile rescue objects 54.1, 54.2, 54.3 can be located with the so-called global positioning system (GPS), so that the current location of the mobile rescue objects 54.1, 54.2, 54.3 is always stored in the central computer 53. In addition, other mobile rescue object data relating to equipment and/or qualification and/or type of the mobile rescue objects 54.1, 54.2, 54.3 can be transmitted to the central computer 53. Mobile rescue objects 54.1 to 54.3, for example, can include emergency physicians, ambulances and rescue vehicles.

Corresponding to the information provided on the accident event 51 and based on the data relating to available mobile rescue objects 54.1, 54.2, 54.3, the central computer 53 determines in a step 55 a momentarily available rescue object. The rescue object, which is assigned based on the requirements of the accident event 51, receives a message on the accident 51 and is directed to the deployment location and/or the accident event. Since the rescue object assigned to the accident event is deployed, a cancellation 56 of the rescue object availability is sent to the central unit 53. The central computer 53 thus stores the information that the rescue object directed to the location of deployment is not (no longer) available for deployment at another accident location.

Once it arrives at the accident 51 location, the insurance card of the accident victim can be scanned in a first step to provide initial medical care to the accident victims. For this, the insurance chip card is provided with features as described in the above for an insurance card and/or storage element according to the invention. In addition, the insurance chip card is provided with a coil, so that on the whole a passive transponder is created.

After recording the patient data, the patient data can be input into a computer, e.g. a laptop, which can establish a network connection to the central computer 53, in particular via a radio link. As an alternative, the patient data are recorded with a mobile computer, i.e. a handheld computer, which is in contact with a mobile base station in the rescue vehicle. The mobile base station in turn has a wireless connection to the central computer 53, wherein the data is preferably encoded for the transfer.

In addition, the accident victims are initially cared for in a step 58, wherein the emergency physician inputs the further treatment requirements into his/her computer. The further treatment requirements are then transmitted to the central computer 53 via the previously mentioned mobile remote data transmission link.

The central computer 53 is furthermore linked with emergency clinics and other hospitals 60.1 to 60.4 via the corresponding connections 61. These stationary rescue installations 60.1 to 60.4 also provide data to the computer 53 on the momentary availability of beds and/or treatment resources. In addition, a stationary rescue unit 60.1 to 60.4 can provide additional data to the central computer 53 relating to personnel qualifications and/or specialized treatment options and specialized equipment, such as diagnostic and treatment devices at the clinic. These data are continuously updated. In particular, it means that if a bed becomes available in a hospital, the central computer is informed of the availability of the bed.

According to yet another modification, the central computer 53 and/or the rescue system can support the diagnosis made by the emergency physician at the scene of the accident in that the system instructs or urges the emergency physician to perform a specific and more comprehensive examination and input the examination results. Inadequate preliminary examinations can thus be reduced or avoided.

Based on the data relating to the available stationary rescue installations 60.1 to 60.4 and with the aid of the transmitted protocol for further treatment, sent by the emergency physician at the scene of the accident 51, the central computer 53 then determines in a further step 59 a respective emergency clinic, which ensures that the accident victim is provided optimum medial care. When selecting the respective emergency clinic with the central computer 53, other factors such as location and qualification of medical personnel can also have an influence.

The central computer 53 then informs of and/or assigns to the mobile rescue object (emergency physician) at the location of deployment the emergency clinic (process step 63). At the same time, the emergency clinic is informed of the accident event 51 and the further treatment requirements and the patient data of the accident victim are transferred to the emergency clinic. The data for the patient to be cared for as well as the patient history and the injuries to the accident victim are thus available to the team of physicians at the emergency clinic while the patient is still treated at the accident location 51 by the emergency physician.

According to one alternative embodiment, the emergency physician at the accident event 51, for example, can request via the mobile data line an additional rescue vehicle, i.e. containing additional equipment, which is then determined by the central computer 53 in accordance with the requirement profile and the availability of rescue objects.

The above-described rescue system with a central computer and/or central unit, mobile rescue objects and stationary rescue installations can be organized on a global as well as a local level, wherein several central computers on the local level can be distributed over different regions and cities and all these computers jointly form the main central unit. As a result, a region can be monitored effectively with respect to the medical care, so that the waiting times and delivery times for the accident victims can be reduced with the method shown herein. More people can thus receive better medical care faster, so that the rescue of individuals can be improved. Based on the regional monitoring, the rescue services can be optimized on the local level as well as the regional level and beyond. In particular, statistics can be gathered through monitoring and/or evaluating data, which can be used to determine the need for mobile rescue objects and stationary rescue installations. Thus, the quality (in particular qualification of physicians and quality of beds and equipment, i.e. in particular optimized beds and related equipment and hospital personnel for people suffering from heart-circulatory illnesses), as well as the quantity (i.e. the number of required rescue vehicles and/or ambulances in the city of Kiel, the number of required emergency medical technicians and/or emergency physicians, the number of required beds, etc) can be determined, in particular for predetermined time periods. The rescue objects and rescue installations can then be optimized accordingly, which also leads to cost savings. The statistical evaluation can be utilized for an improved positioning of the ambulances.

Within the framework of this invention, the term individual-specific data in particular also includes animal-specific data.

Reference Number List

10 insurance card

11 logon authorization card

12 computer

13 keyboard

14 computer

15 computer memory

16, 17, 18, 19, storage area

20 connection device

21 transponder

22 linking line/connecting line

25 memory

26 memory

27 storage area

28 storage area

29 data transmission

30 monitor

51 accident event

52 report (of the accident)

53 central computer

54.1 to 54.3 mobile rescue objects

55 determination of rescue objects

56 canceling of rescue object availability

57 recording of patient data

58 initial care/further treatment requirements

59 determination of emergency clinic

60.1 to 60.4 stationary rescue installations

61 link/connection

53 admitting/allocation

100 start

101 insertion of insurance card

102 reading of master data

103 display of master data on the monitor

104 inquiry as to “removal of insurance card”

105 end

106 insertion field

107 start of insertion “physician”

108 insertion of logon card

109 checking for logon authorization

110 end of insertion by “physician”

110 waiting for PIN code and checking PIN code

112 counter

113 counter>3?

114 displayed warning

115 display of additional fields

116 removal of access card?

117 data input

118 change of data on the insurance card

200 start at pharmacy

201 insertion of insurance card

202 transfer of logon authorization for prescription field

203 logon authorization O.K?

204 display of data in the prescription field and deleting of data in the

prescription field

205 end “pharmacy”

w: true

f: false

j: yes

n: no

1. A storage element (25) for storing individual-specific data, said storage element having at least two storage areas, characterized in that different logon authorizations are assigned to the storage areas.

2. The storage element (25) according to claim 1, characterized in that at least one storage area is configured as ROM and at least one storage area is configured as RAM.

3. The storage element (25) according to claim 1 and/or claim 2, characterized in that the storage element (25) is an integral element.

4. The storage element (25) according to one or several of the claims 1 to 3, characterized in that the storage element is disposed on a flat configuration (10), in particular on a card.

5. The storage element (25) according to one or several of the claims 1 to 4, characterized in that the storage content of the at least two storage areas is provided with a different coding for each storage area.

6. A system for detecting and storing individual-specific data, said system comprising a computer (12), in particular a portable storage element (10) according to one or several of the claims 1 to 5, and a connection device (20), wherein the storage element (10) engages in the connection device (20) in such a way that data from the storage element (10) can be read into the computer (12) and/or can be written from the computer (12) onto the storage element.

7. The system according to claim 6, characterized in that a logon element (11) is additionally provided, by means of which the data can be transmitted directly to the computer (12) and/or via the computer (12) to the connection device, wherein the data contain at least a portion of the logon authorization.

8. The system according to claim 7, characterized in that an additional portion of the logon authorization can be transmitted via a communication means (13) in the form of data to the computer (12) and/or via the computer (12) to the connection device (20).

9. The system according to one or several of the claims 6 to 8, characterized in that means for the remote data transmission are provided.

10. A system for detecting and storing individual-specific data, said system comprising a first computer (14), which contains different storage areas (16 to 19) on a computer storage element (15), wherein at least in part different logon authorizations are assigned to the different storage areas (16 to 19), further comprising a portable storage element (10) for storing data and a connection device (20), wherein the portable storage element (10) can be made to engage in the connection device (20) in such a way that data from the portable storage element (10) can be transmitted to the first computer (14), wherein the individual-specific data in one of the areas (16 to 19) with logon authorization of the computer storage element (15) can be read and/or changed by entering a respective logon authorization or using an existing one.

11. The system according to claim 10, characterized in that means for the remote data transmission are provided, wherein data from the first computer (14) can be transmitted to a different, second computer (12) that is assigned to another connection device (20).

12. The system according to one or several of the claims 6 to 11, characterized in that an electromagnetic signal can be transmitted and received with the connection device (20) for recognizing the data on the portable storage element (10) or a different element, wherein the portable storage element (10) comprises a transponder (21).

13. A method for reading and/or writing data on a first storage element (15, 25) according to one or several of the claims 1 to 5, wherein for reading and/or writing data on a storage area (16 to 19) of the first storage element (15, 25), which is at least in part secured with at least one logon authorization, a logon authorization is supplied to a storage area (27, 28) of a second storage element (15, 26) and is compared to at least one logon authorization specified on the first storage element (15, 25) and wherein if the logon authorization matches at least one of the specified logon authorizations, the storage area (16 to 19) of the first storage element (15, 25) to which this logon authorization is assigned is made accessible.

14. The method according to claim 13, characterized in that for displaying the released data, the data from the first storage element (15, 25) are read into another storage area (28, 27) of the second storage element (15, 26) and are supplied to a display unit (30).

15. The method according to claim 13 and/or 14, characterized in that for writing on the cleared storage area (16 to 19) of the first storage element (15, 25), data are input into the second storage element (15, 26) and are transferred from the second storage element to the unblocked area (16 to 19) of the first storage element (15, 25), where they are stored.

16. A computer program with program code for realizing all the steps according to one or several of the claims 13 to 15 if the program runs on a computer.

17. The computer program with program code, stored on a machine-readable carrier, for realizing the method according to one or several of the claims 13 to 15 if the program runs on a computer.

18. The use of a storage element (25), arranged on a card (10) for storing and/or changing individual-specific data in the area of health services and in particular in the area of emergency medical care, so that the case histories of accident patients can be detected quickly.

19. A method for rescuing and/or medically caring for living beings in emergency situations, in particular people involved in accidents, wherein a central unit (53) contains in particular current data on mobile rescue objects (54.1, 54.2, 54.3), in particular data on emergency physicians, emergency medical technicians, emergency-room physicians, ambulances and/or rescue vehicles and that following a report of an accident event (51) involving living beings to the central computer (53), a suitable rescue object (54.1, 54.2, 54.3) is assigned to the central unit (53) to the accident event (51) on the basis of the data underlying the accident event (51) and/or with the aid of data available on mobile rescue objects (54.1, 54.2, 54.3) and that the central unit subsequently sends a message concerning the accident event (51) to the at least one assigned mobile rescue object (54.1, 54.2, 54.3).

20. The method according to claim 19, characterized in that the data on the mobile rescue objects (54.1, 54.2, 54.3) comprise data on the availability and/or the location and/or the qualification and that these data are transmitted to the central unit (53).

21. The method according to claim 19 or 20, characterized in that the data and/or the location of a mobile rescue object (54.1, 54.2, 54.3) are transmitted with GPS support to the central unit (53).

22. The method according to one or several of the claims 19 to 21, characterized in that the data on the mobile rescue objects (54.1, 54.2, 54.3) are updated, preferably at predetermined time intervals.

23. The method according to one or several of the claims 19 to 22, characterized in that a request for another mobile rescue object (54.1, 54.2, 54.3) is transmitted to the central unit (53) and that the central unit (53) assigns at least one additional mobile rescue object (54.1, 54.2, 54.3) to the accident event (51) on the basis of the request message and/or based on the data available for mobile rescue objects (54.1, 54.2, 54.3) and then sends a message to the additional mobile rescue object (54.1, 54.2, 54.3).

24. The method according to one or several of the claims 19 to 23, characterized in that following the report of the accident event (51) to the mobile rescue object (54.1. 54.2, 54.3), the rescue object (54.1, 54.2, 54.3) transmits a message (56) canceling the availability of the rescue object to the central unit (53).

25. The method according to one or several of the claims 19 to 24, characterized in that the central unit (53) is linked to stationary rescue installations (60.1 to 60.4) and has available data, in particular current data, on the stationary rescue installations (60.1 to 60.4).

26. The method according to one or several of the claims 19 to 25, characterized in that following a message from the mobile rescue object (54.1, 54.2, 54.3) to the central unit (53), detailing the need for further treatment of the living being, a rescue installation (60.1 to 60.4) is determined based on the need for further treatment and/or based on the data available on stationary rescue installations (60.1 to 60.4) and that the data relating to the rescue installation are then transmitted to the rescue object (54.1 to 54.3).

27. The method according to one or several of the claims 19 to 26, characterized in that during and/or after the living being is cared for, data is exchanged, in particular patient data and/or data relating to the further treatment, between the mobile rescue object (54.1 to 54.3) and the central unit (53).

28. The method according to one or several of the claims 25 to 27, characterized in that the data relating to the stationary rescue installations (60.1 to 60.4) contains information on whether the rescue installation (60.1 to 60.4) is available and/or is qualified and/or is reachable and that this information is transmitted.

29. The method according to one or several of the claims 25 to 28, characterized in that the data on the stationary rescue installations (60.1 to 60.4) are updated, preferably at predetermined time intervals and/or following a change in the data.
